(19) United States
(12) Patent Application Publication
(10) Pub. No.: US 2025/0295946 A1
(43) Pub. Date: Sep. 25, 2025

(54) FIRE-FIGHTING COMPOSITIONS

(71) Applicant: Government of the United States as represented by the Secretary of the Air Force, Wright-Patterson AFB, OH (US)

(72) Inventors: Jeffery R. Owens, Panama City, FL (US); Katherine M. Simpson, Panama City, FL (US)

(21) Appl. No.: 19/061,009

(22) Filed: Feb. 24, 2025

Related U.S. Application Data
(60) Provisional application No. 63/568,224, filed on Mar. 21, 2024.

(51) Int. Cl. A62D 1/02

(52) U.S. Cl. CPC A62D 1/0078

(57) ABSTRACT

The present invention relates to non-AFFF firefighting compositions and methods of making and using same. Applicants disclose firefighting compositions that comprise a wetting agent and a thickening agent. Such thickening agent captures and changes the chemical properties of fuel vapors as they permeate around and through the bubbles of a firefighting composition. Such firefighting compositions are particularly useful in fighting Class B fires.

### CROSS-REFERENCE TO RELATED APPLICATIONS

The present application claims priority to U.S. Provisional Application Ser. No. 63/568,224 filed Mar. 21, 2024, the contents of such provisional application hereby being incorporated by reference in its entry.

### RIGHTS OF THE GOVERNMENT

The invention described herein may be manufactured and used by or for the Government of the United States for all governmental purposes without the payment of any royalty.

### FIELD OF THE INVENTION

The present invention relates to fire-fighting compositions comprising a wetting agent and a thickener, as well as methods of making and using such compositions.

### BACKGROUND OF THE INVENTION

The capability to suppress fires such as class B, F, and K fires is of particular important to a number of industries including the fuel and aircraft industries. Class B fires include flammable liquids or flammable gases, petroleum greases, tars, oils, oil-based paints, solvents, lacquers, alcohols, rubbers, and plastics. For example, propane, natural gas, gasoline, kerosene, rubber, and plastic fires are types of Class B fires. Class F, known in the United States as Class K, refers to fires involving cooking oil or fat and are a subset of Class B fires.

The most efficient method for extinguishing class B fires involves using firefighting foams called Aqueous Film Forming Foams (AFFF). Unfortunately, AFFFs contain fluorinated surfactants classified as per- and polyfluoroalkyl substances (PFAS). These fluorocarbon surfactants have a number of undesirable properties. Thus, the US Congress's 2020 National Defense Authorization Act (NDAA) prohibits DoD use of AFFFs after 1 Oct. 2024. Since that announcement researchers and the firefighting industry have been scrambling to find an effective alternative to AFFF. However, the commercially available alternatives still lack the distinctive performance of AFFFs.

Applicants recognized that the problem with current non-fluorinated surfactant firefighting compositions was that such compositions allow the permeation of fuel vapors around and through the bubbles of such compositions. Thus, Applicants recognized that a substance that could capture and change the chemical properties of such fuel vapors was needed in order to have an effective firefighting composition. As a result, Applicants disclose firefighting compositions that comprise a wetting agent and a thickening agent. Such thickening agent captures and changes the chemical properties of fuel vapors as they permeate around and through the bubbles of a firefighting composition. Such firefighting compositions are particularly useful in fighting Class B fires. While not being bound by theory, Applicants believe that such thickening agents achieve the aforementioned objective by complexing with a fire's fuel.

### SUMMARY OF THE INVENTION

The present invention relates to non-AFFF firefighting compositions and methods of making and using same. Applicants disclose firefighting compositions that comprise a wetting agent and a thickening agent. Such thickening agent captures and changes the chemical properties of fuel vapors as they permeate around and through the bubbles of a firefighting composition. Such firefighting compositions are particularly useful in fighting Class B fires.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts time to extinguish a Class B (ethanol free gasoline fire) using four different concentrates that are mixed with water, on a weight based on total composition weight, wherein said water is 97% of said composition and said concentrate is 3% by weight of said composition wherein COTDS control is Dawn™ Dish Soap, A2.5 is 2.5% aluminum 2-ethylhexanoate used on a total Dawn™ Dish Soap, aluminum 2-ethylhexanoate weight basis, and F2.5 is xanthan gum used on a total Dawn™ Dish Soap weight basis and the mixture that contains Dawn™ Dish Soap, aluminum 2-ethylhexanoate and xanthan gum is a composition that, based on total composition weight contains 95% Dawn™ Dish Soap, 2.5% aluminum 2-ethylhexanoate and 2.5% xanthan gum. Each water and concentrate mixture is foamed and applied to the fire.

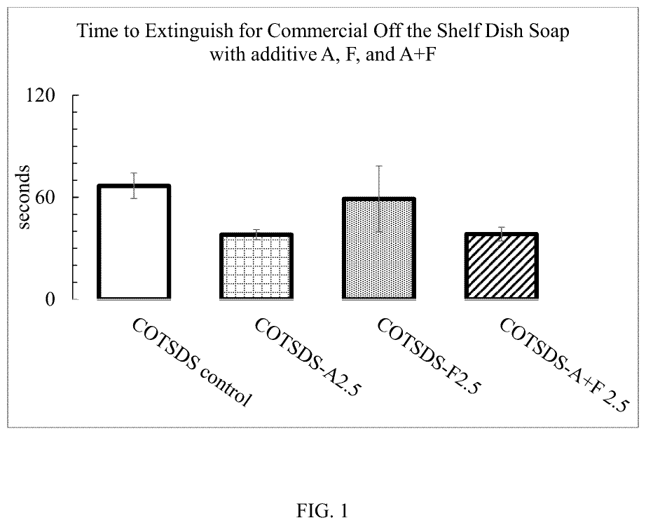

FIG. 2 depicts the burn back time of a Class B (ethanol free gasoline fire) using four different concentrates that are mixed with water, on a weight based on total composition weight, wherein said water is 97% of said composition and said concentrate is 3% by weight of said composition wherein COTDS control is Dawn™ Dish Soap, A2.5 is 2.5% aluminum 2-ethylhexanoate used on a total Dawn™ Dish Soap, aluminum 2-ethylhexanoate weight basis, and F2.5 is xanthan gum used on a total Dawn™ Dish Soap weight basis and the mixture that contains Dawn™ Dish Soap, aluminum 2-ethylhexanoate and xanthan gum is a composition that, based on total composition weight contains 95% Dawn™ Dish Soap, 2.5% aluminum 2-ethylhexanoate and 2.5% xanthan gum. Each water and concentrate mixture is foamed and applied to the fire and said test is conducted per a small scale version of MILSPEC liquid fuel test (MIL-PRF-24385F). Each water and concentrate mixture is foamed and applied to the fire.

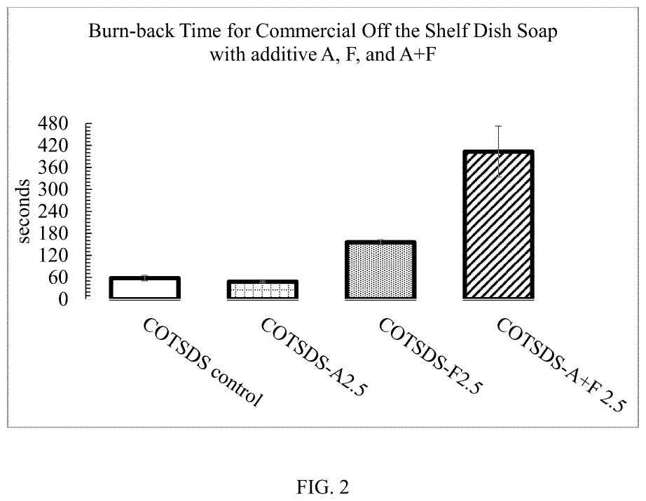

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, “aqueous foaming agent” means a substance that, when added to water and sprayed, agitated, aspirated with a gas, or sparged, generates an aqueous foam.

As used herein, “burnback” means the time it takes for a non-extinguished area of a class B fire to spread across the extinguished areas and degrade the foam blanket to the point that the fuel is re-ignited.

As used herein, “Class B fire” means a fire comprised of one or more hydrocarbon fuels.

As used herein, “compound” means a material formed by chemically bonding two or more chemical elements.

As used herein, “fuel thickener” means a substance that, when combined with a hydrocarbon fuel, lowers the fuel's vapor pressure.

As used herein, “hydrocarbon fuel” means, as defined by class B fires—flammable liquids or flammable gases, petroleum greases, tars, oils, oil-based paints, solvents, lacquers, alcohols, rubbers, and plastics. For example, propane, natural gas, gasoline, kerosene, jet fuel, diesel fuel, rubber, plastic, etc. fires are types of Class B fires. Class F, known in the United States as Class K, refers to fires involving cooking oil or fat and are a subset of Class B fires.

As used herein, “natural product” means any chemical and mixtures thereof made by a living organism.

As used herein, “per and polyfluoroalkyl substances” mean a synthetic chemical or natural product that is chemically modified said synthetic chemical and chemically modified natural product having two or more covalent bonds to fluorine.

As used herein, “soap” means an emulsifying agent.

As used herein, “substance” means a mixture of two or more compounds.

As used herein, “synthetic” means a compound or substance that is man-made by synthesis, rather than being produced by a living organism.

As used herein, “wetting agent” means a compound or substance that increases the water content of the foam generated from an aqueous foaming agent. \

### Fire-Fighting Compositions and Use of Same

For purposes of this specification, headings are not considered paragraphs. The individual number of each paragraph above and below this paragraph can be determined by reference to this paragraph. In this paragraph, Applicants disclose a composition comprising at least one aqueous foaming agent, at least one fuel thickening agent and at least one wetting agent.

In this paragraph, Applicants disclose the composition of the previous paragraph wherein:
a) said at least one aqueous foaming agent comprises:
   (i) a synthetic compound, natural product, and/or chemically modified natural product; and/or
   (ii) a nonionic, cationic, anionic, polyionic, zwitterionic, and/or amphoteric material; preferably said material comprises a surfactant, preferably said surfactant comprises a nonionic surfactant; preferably said nonionic surfactant comprises triblock copolymers of poly(ethylene oxide)-poly(propylene oxide)-poly(ethylene oxide;
b) said at least one fuel thickening additive comprises an alkali metal soap, aluminum 2-ethylhexanoate, and/or aluminum naphthenate, preferably said fuel thickening additive comprises aluminum 2-ethylhexanoate; and
c) said at least one wetting agent comprises a polyester, polyol, polysiloxane, polyamine, polycarboxylate, polysulfate and/or polyphosphate; preferably said polyol comprises a polysaccharide, in one aspect, said wetting agent comprises carrageenan, chitosan, chitin, agar, alginin, collagen, albumin, gelatin, xanthan gum and/or carrageenan. Alkali metal soaps can be made from fatty acids such as Caprylic acid, Capric acid, Lauric acid, Myristic acid, Pentadecanoic acid, Palmitic acid, Heptadecanoic acid, Stearic acid and Arachidic acid. Polyols are polymeric compounds having two or more-OH functional groups, polysiloxane are polymeric compounds having two or more (—Si—O—) functional groups, polyamines are polymeric compounds having two or more amine, amide, imide, or nitrile functional groups, polycarboxylates are polymeric compounds having two or more (—COOH) functional groups, polysulfates are polymeric compounds having two or more sulfone, sulfate, or sulfonate functional groups and polyphosphates are polymeric compounds having two or more (—PO₄) functional groups.

In this paragraph, Applicants disclose the composition of the previous two paragraphs said composition having a ratio of wetting agent to foaming agent of from about 0.05:1 to about 1:10; and/or a ratio of fuel thickening agent of from about 0.05:1 to about 0.5:10.

In this paragraph, Applicants disclose the composition of the previous three paragraphs wherein the fuel thickening additive comprises one or more alkali metal soaps.

In this paragraph, Applicants disclose a method of extinguishing or reducing a fire comprising applying a composition according to the previous four paragraphs to a fire.

In this paragraph, Applicants disclose the method of extinguishing or reducing a fire according to the previous paragraph wherein said fire is a Class B fire.

In this paragraph, Applicants disclose the method of extinguishing or reducing a fire according to the previous two paragraphs said composition is foamed prior to being applied to said fire.

In this paragraph, Applicants disclose the method of the previous paragraph wherein said composition of is foamed prior to being applied to said fire by compressed air foaming and/or aspirated foaming.

In this paragraph, Applicants disclose a foam comprising a composition of the first four paragraphs of this section of the specification titled “Fire-fighting Compositions and Use of Same” and a gas, said foam having a composition to gas weight ratio of about 5:1 to about 20:1, preferably said foam has a composition to gas weight ratio of about 10:1 to about 14:1, more preferably said foam has a composition to gas weight ratio of about 11:1 to about 13:1. In one aspect, said foam has a composition to gas weight ratio of 12:1.

In this paragraph, Applicants disclose a method of extinguishing or reducing a fire comprising applying the foam according to the previous paragraph to a fire.

In this paragraph, Applicants disclose the method of extinguishing or reducing a fire according to the previous paragraph wherein said fire is a Class B fire.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: For initial proof-of-concept a commercial off-the-shelf (COTS) aqueous foaming agent not designed for Class B fire suppression (dish soap) was purchased and tested with and without additives according to the following procedure. Testing was accomplished via a scaled-down version of the 28 square foot fire test described in MIL-PRF-24385F section 4.7.13.1. The COTS aqueous foaming agent is mixed with water at 3% vol/vol concentration in a five-gallon bucket. A hose leading to the compressed air nozzle is placed in the foam-water mixture and pumped at a rate of 80 mL/min. The liquid is then mixed with compressed air set to 0.85 L/s to generate the aqueous foam. A 19 cm diameter, 12 cm deep pan is filled with 600 mL of water and 300 mL of ethanol free gasoline. The gasoline is ignited and allowed to burn for 30 seconds before the pan is slid under the flowing foam nozzle. The time to gain 90% control over the fire and the time to extinguish is recorded. The burn-back pan, 4 cm in diameter, is filled with 5-10 mL of gasoline and ignited. The flaming fuel is lowered into the extinguished fuel/foam mixture and the time to reignite the fuel pan is recorded. All fire testing is performed in triplicate.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A composition comprising at least one aqueous foaming agent, at least one fuel thickening agent and at least one wetting agent.

2. The composition of claim 1 wherein:
a) said at least one aqueous foaming agent comprises:
(i) a synthetic compound, natural product, and/or chemically modified natural product; and/or
(ii) a nonionic, cationic, anionic, polyionic, zwitterionic, and/or amphoteric material;
b) said at least one fuel thickening additive comprises an alkali metal soap, aluminum 2-ethylhexanoate, and/or aluminum naphthenate; and
c) said at least one wetting agent comprises a polyester, polyol, polysiloxane, polyamine, polycarboxylate, polysulfate and/or polyphosphate.

3. The composition of claim 2 wherein:
a) said nonionic, cationic, anionic, polyionic, zwitterionic, and/or amphoteric material comprises a surfactant;
b) said at least one fuel thickening additive comprises aluminum 2-ethylhexanoate; and
c) said polyol comprises a polysaccharide.

4. The composition of claim 3 wherein said surfactant comprises a nonionic surfactant.

5. The composition of claim 4 wherein said nonionic surfactant comprises triblock copolymers of poly(ethylene oxide)-poly(propylene oxide)-poly(ethylene oxide.

6. The composition of claim 2 wherein said wetting agent comprises carrageenan, chitosan, chitin, agar, alginin, collagen, albumin, gelatin, xanthan gum and/or carrageenan.

7. The composition of claim 1 having:
a) a ratio of wetting agent to foaming agent of from about 0.05:1 to about 1:10; and/or
b) a ratio of fuel thickening agent of from about 0.05:1 to about 0.5:10.

8. The composition of claim 1 wherein the fuel thickening additive comprises one or more alkali metal soaps.

9. A method of extinguishing or reducing a fire comprising applying a composition of claim 1 to a fire.

10. The method of extinguishing or reducing a fire according to claim 9 wherein said fire is a Class B fire.

11. The method of extinguishing or reducing a fire according to claim 9 wherein said composition is foamed prior to being applied to said fire.

12. The method of claim 11 wherein said composition is foamed, prior to being applied to said fire, by compressed air foaming and/or aspirated foaming.

13. A foam comprising a composition of claim 1 and a gas, said foam having a composition to gas weight ratio of about 5:1 to about 20:1,

14. The foam of claim 13, said foam having a composition to gas weight ratio of about 10:1 to about 14:1.

15. The foam of claim 14, said foam having a composition to gas weight ratio of about 11:1 to about 13:1.

16. The foam of claim 13, said foam having a composition to gas weight ratio of 12:1.

17. A method of extinguishing or reducing a fire comprising applying the foam of claim 13 to a fire.

18. The method of claim 17 wherein said fire is a Class B fire.
